(19) United States
(12) Patent Application Publication
(10) Pub. No.: US 2018/0191109 A1
(43) Pub. Date: Jul. 5, 2018

(54) EQUIPMENT CABINET ENABLING QUICK CONNECTION/DISCONNECTION OF ADAPTER SOCKET

(71) Applicant: AVIC JONHON OPTRONIC TECHNOLOGY CO., LTD, Henan (CN)

(72) Inventors: Xiangyang LIU, Henan (CN); Wei XU, Henan (CN)

(73) Assignee: AVIC JONHON OPTRONIC TECHNOLOGY CO., LTD, Henan (CN)

(21) Appl. No.: 15/740,349

(22) PCT Filed: Sep. 17, 2015
(86) PCT No.: PCT/CN2015/089886

§ 371 Date: Dec. 28, 2017

(30) Foreign Application Priority Data
Jun. 28, 2015 (CN) 201510361202.3

(51) Int. Cl. H01R 13/74; H01R 12/71; H01R 24/68

(52) U.S. Cl. CPC H01R 13/748; H01R 24/68; H01R 12/716

(57) ABSTRACT

An equipment cabinet enabling quick connection/disconnection of an adapter socket, including the adapter socket and a cabinet body having an installation panel. The cabinet body is provided with a PCB (Printed Circuit board) therein. The equipment cabinet further includes an auxiliary socket, wherein a contact of the auxiliary socket provided inside the cabinet body is electrically connected to the PCB. The auxiliary socket is disposed on the cabinet body or on the PCB and has an auxiliary socket plug-connected terminal facing towards the installation panel. The installation panel is provided with a socket opening exactly corresponding to the auxiliary socket plug-connected terminal. An inner end of the adapter socket is an adapter socket inner plug-connected terminal inserting into the socket opening from the outside to the inside and plug-connected to the auxiliary socket plug-connected terminal. By providing the auxiliary socket on the PCB or on the cabinet body, the present invention can insert the adapter socket inner plug-connected terminal of the adapter socket into the socket opening from the outside to the inside to plug-connect to the auxiliary socket plug-connected terminal, such that when the adapter socket has a failure and needs to be removed, the adapter socket can be removed directly without opening the equipment cabinet, thus making disconnection of the adapter socket easy and convenient.

### BACKGROUND OF THE INVENTION

### 1. Field of the Invention

The present invention relates to an equipment cabinet enabling quick connection/disconnection of an adapter socket.

### 2. Description of Related Art

An existing equipment cabinet is shown in FIG. 1. The equipment cabinet includes a cabinet body having an installation panel. A PCB (Printed Circuit Board) is disposed in the cabinet body, an adapter socket is disposed on the installation panel, an inner end of the adapter socket is weld-connected to a lead wire, the lead wire is fixed onto the PCB by using a screw, and an outer end of the adapter socket is a plug-connected terminal configured to plug-connect to an adaptation connector. When equipment inside the cabinet needs to connect to equipment outside the cabinet, a connector adapted to the adapter socket is used to plug-connect to the adapter socket to achieve a connection between the equipment inside and outside the cabinet. A problem of the existing equipment cabinet is that when the adapter socket has a failure and needs to be repaired, the adapter socket cannot be immediately removed and replaced because a tail portion of the lead wire is fixed onto the PCB by using the screw. The adapter socket can be removed only by disassembly of the cabinet. Consequently, removal of the adapter socket is very inconvenient.

### SUMMARY OF THE INVENTION

The present invention is directed to provide an equipment cabinet enabling an adapter socket to be removed without opening the cabinet.

To resolve the foregoing problem, technical solutions of the present invention are as follows:

An equipment cabinet is provided. The equipment cabinet includes an adapter socket and a cabinet body having an installation panel. The cabinet body is provided with a PCB (Printed Circuit Board) therein. The equipment cabinet further includes an auxiliary socket, wherein a contact of the auxiliary socket provided inside the cabinet body is electrically connected to the PCB. The auxiliary socket is disposed on the cabinet body or on the PCB and has an auxiliary socket plug-connected terminal facing towards the installation panel. The installation panel is provided with a socket opening exactly corresponding to the auxiliary socket plug-connected terminal, and an inner end of the adapter socket is an adapter socket inner plug-connected terminal inserting into the socket opening from the outside to the inside and plug-connecting to the auxiliary socket plug-connected terminal.

The auxiliary socket is disposed on the PCB, and the contact of the auxiliary socket is provided with a welding pin that is weld-connected to the PCB.

An outer end of the adapter socket is an adapter socket outer plug-connected terminal configured to plug-connect to an adaptation connector, and the adapter socket is provided with a square plate for stopping and matching with an outer panel surface of the installation panel.

A screw opening whose axis extends along an inside-outside direction is provided on the square plate, a threaded hole corresponding to the screw opening is disposed on the installation panel, and a locking screw is mounted through the screw opening and the threaded hole.

An beneficial effect of the present invention is: by providing the auxiliary socket on the PCB or on the cabinet, the present invention can insert the adapter socket inner plug-connected terminal of the adapter socket into the socket opening from the outside to the inside and plug-connect to the auxiliary socket plug-connected terminal, such that when the adapter socket has a problem and needs to be removed, the adapter socket can be removed directly without opening the cabinet, thus making disconnection of the adapter socket easy and convenient.

### BRIEF DESCRIPTION OF THE DRAWINGS

FIG. 1 is a schematic structural diagram of the related art of the present invention.

FIG. 2 is a schematic structural diagram of an embodiment of the present invention.

FIG. 3 is a schematic diagram of the matching between an adapter socket and an auxiliary socket in FIG. 2.

FIG. 4 is a schematic structural diagram of the adapter socket in FIG. 3.

FIG. 5 is a schematic structural diagram of the auxiliary socket in FIG. 3.

FIG. 6 is a schematic diagram of the matching of the auxiliary socket with a PCB and an installation panel.

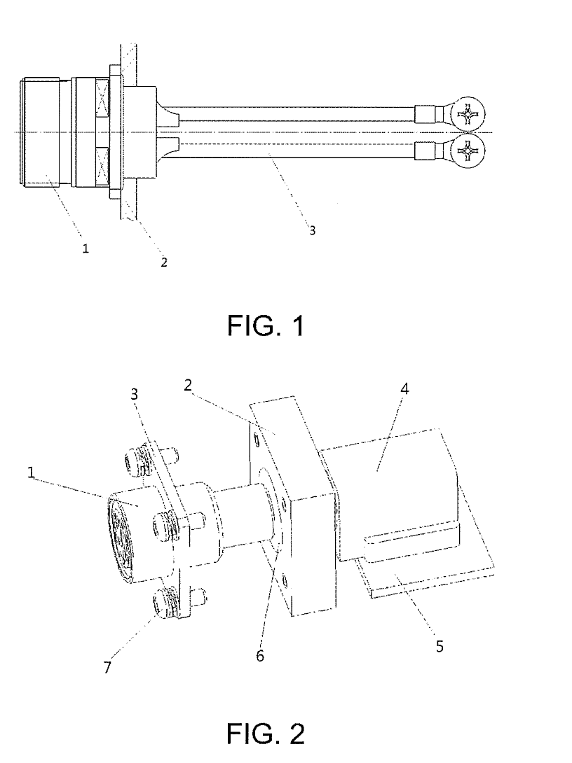

### DESCRIPTION OF THE EMBODIMENTS

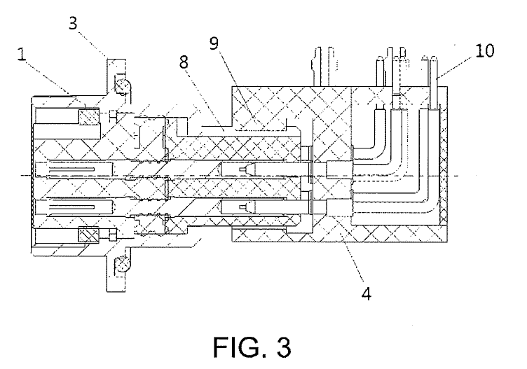

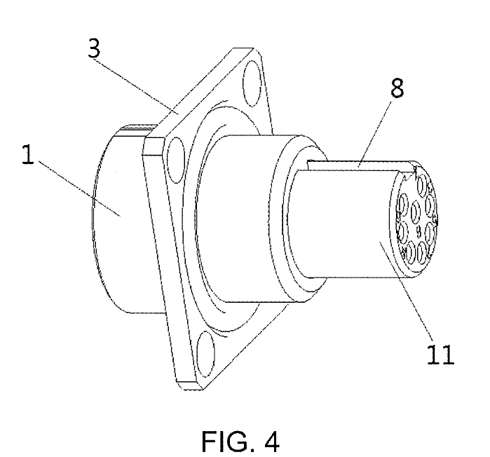

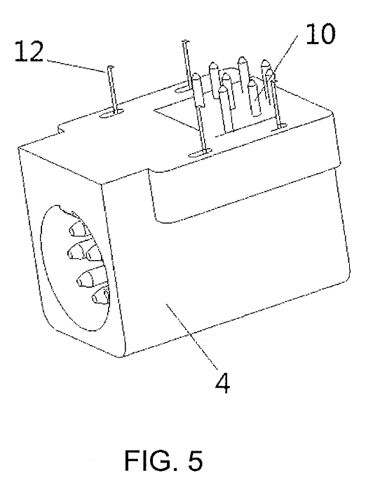

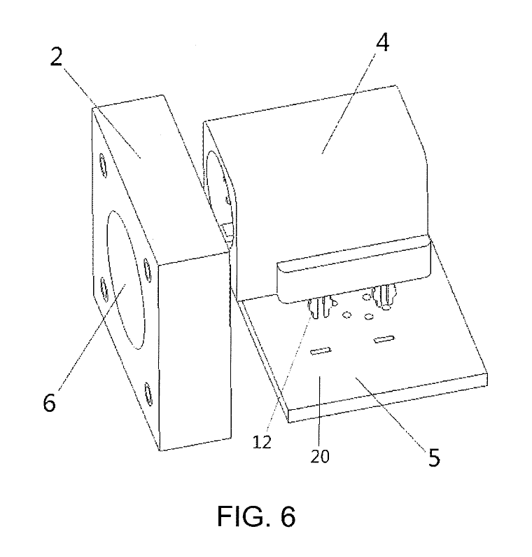

An embodiment of an equipment cabinet enabling quick connection/disconnection of an adapter socket is shown in FIG. 2 to FIG. 6. The equipment cabinet enabling quick connection/disconnection of an adapter socket includes an adapter socket 1 and a cabinet body having an installation panel 2. A PCB 5 (that is, a printed circuit board) and an auxiliary socket 4 are disposed in the cabinet body. In the present embodiment, the auxiliary socket 4 is a PCB socket disposed on the PCB. A contact of the auxiliary socket 4 is provided with a welding pin 10 that is weld-connected to the PCB. The auxiliary socket 4 has an auxiliary socket plug-connected terminal facing towards the installation panel 2. Barbs 12 for fixing the auxiliary socket onto the PCB are provided on the auxiliary socket, and each barb is of a structure of two elastic valves. A slot 20 corresponded with the barb 12 is provided on the PCB. During mounting, a force is applied to the two elastic valves to make the two elastic valves relatively close, and then the two elastic valves are mounted into the slot. After the elastic valves are loosened, the elastic valves return to the original shapes, and barbs on the elastic valves clamp the slot, thereby fixing the auxiliary socket. A socket opening 6 exactly corresponding to the auxiliary socket plug-connected terminal is provided on the installation panel. An inner end of the adapter socket 1 is an adapter socket inner plug-connected terminal 11 inserting into the socket opening from the outside to the inside and plug-connecting to the auxiliary socket plug-connected terminal. A guide key slot 8 extending along an inside-outside direction is provided on the adapter socket inner plug-connected terminal. A guide key 9 for guiding and matching with the guide key slot is provided on the auxiliary socket plug-connected terminal. An outer end of the adapter socket is an adapter socket outer plug-connected terminal configured to plug-connect to an adaptation connector. The adapter socket is provided with a square plate 3 for stopping and matching with an outer panel surface of the installation panel. A screw opening whose axis extends along an inside-outside direction is provided on the square plate, a threaded hole corresponding to the screw opening is provided on the installation panel, and a locking screw 7 is mounted through the screw opening and the threaded hole.

During use, the auxiliary socket is disposed on the PCB, and the auxiliary socket plug-connected terminal of the auxiliary socket corresponds to the socket opening on the installation panel. After being inserted into the socket opening from the outside to the inside, the adapter socket inner plug-connected terminal of the adapter socket is plug-connected to the auxiliary socket plug-connected terminal until the installation panel stops the square plate, thereby an electrical connection between the adapter socket and the PCB is achieved. Then, after locking the locking screw the mounting process of the adapter socket is completed. When the adapter socket has a failure, the adapter socket may be dismounted and replaced with a new adapter socket after removing the locking screw. With the auxiliary socket directly disposing on the PCB, the structure of the product may be simplified, and the corresponding lead wire part is omitted. After the square plate is stopped by the installation panel, the auxiliary socket is plug-connected to the adapter socket, thereby avoiding over plug-connection between the adapter socket and the auxiliary socket, which a welding failure surely can be between the welding pin of the auxiliary socket and the PCB under an external force along an inside-outside direction. As the adapter socket is fixed onto the installation panel by using the locking screw, the adapter socket is supported by the installation panel, a welding failure of the welding pin caused by the adapter socket being excessively presses down the auxiliary socket can also be avoided.

In other embodiments of the present invention: Alternatively, the auxiliary socket may be fixedly disposed on the cabinet body. In this case, the auxiliary socket may be connected to the PCB by using a lead wire. An outer end of the adapter socket may not be a plug-connected terminal. For example, a signal is led into the adapter socket or led out from the adapter socket by using the lead wire. Certainly, the adapter socket may be fixed by means of a plug-connection force between the adapter socket and the auxiliary socket. In this case, the square plate and the locking screw do not need to be provided.

1. An equipment cabinet, comprising an adapter socket and a cabinet body having an installation panel, the cabinet body provided with a PCB (Printed Circuit Board) therein, characterized in that: wherein the equipment cabinet further comprises an auxiliary socket, a contact of the auxiliary socket provided inside the cabinet body is electrically connected to the PCB, the auxiliary socket is disposed on the cabinet body or on the PCB and has an auxiliary socket plug-connected terminal facing towards the installation panel, the installation panel is provided with a socket opening exactly corresponding to the auxiliary socket plug-connected terminal, and an inner end of the adapter socket is an adapter socket inner plug-connected terminal inserting into the socket opening from the outside to the inside and plug-connecting to the auxiliary socket plug-connected terminal.

2. The equipment cabinet according to claim 1, wherein the auxiliary socket is disposed on the PCB, and the contact of the auxiliary socket is provided with a welding pin that is weld-connected to the PCB.

3. The equipment cabinet according to claim 2, wherein an outer end of the adapter socket is an adapter socket outer plug-connected tell Anal configured to plug-connect to an adaptation connector, and the adapter socket is provided with a square plate for stopping and matching with an outer panel surface of the installation panel.

4. The equipment cabinet according to claim 2, wherein a screw opening whose axis extends along an inside-outside direction is provided on the square plate, a threaded hole corresponding to the screw opening is disposed on the installation panel, and a locking screw is mounted through the screw opening and the threaded hole.

5. The equipment cabinet according to claim 3, wherein a screw opening whose axis extends along an inside-outside direction is provided on the square plate, a threaded hole corresponding to the screw opening is disposed on the installation panel, and a locking screw is mounted through the screw opening and the threaded hole.
